(19) United States
(12) Patent Application Publication
(10) Pub. No.: US 2009/0107218 A1
(43) Pub. Date: Apr. 30, 2009

(54) Test separator

(75) Inventor: Terry Lee Latham, Kingfisher, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(73) Assignee: Chesapeake Operating, Inc.

(21) Appl. No.: 11/980,018

(22) Filed: Oct. 30, 2007

(51) Int. Cl. G01N 1/10

(52) U.S. Cl. 73/61.44

(57) ABSTRACT

A mobile test separator has a separator unit mounted on a wheeled trailer movable between test sites. The separator unit separates well production stream into a liquid production stream and a gas production stream. The separator unit effectively measures the amount of oil and gas in the production stream.

### BACKGROUND

The current disclosure relates to separator systems and methods for measuring production volumes of wells when the production includes a mixture of oil, gas and water.

Oil, gas and water are often produced simultaneously produced from a well drilled for the production of hydrocarbons. The production stream from the well may be separated into its component parts, so that the oil and gas therein can be marketed. Well data generally must be acquired by an operator so the particular well, or group of wells, can be properly managed and evaluated. Such test data may include, for example, wellhead pressure data and flow rates for the respective oil, water and gas components of a production stream. Such information is useful for a variety of reasons, including, but not limited to, allowing an operator to optimize production from a single well, or group of wells.

Test separators are used to separate the production stream into its component parts and to provide information regarding the production stream, including the rate of flow of gas and liquid in a mixed production stream. Test separators in some cases can also provide information regarding the amount of oil and water in the liquid portion of the production stream. Current test separators are limited in their efficiency in that each must be specifically configured for defined flow rates, and many are large stationary structures which cannot be easily moved to different test locations. Additionally, common portable test units require additional pressure to be used in their operation in order for the fluids to be delivered back into the well flow line system. This can and does cause an inaccuracy in the testing of some wells by imposing higher than normal pressures against the flow stream from the well which may cause the performance of the well to be altered since it must produce against this higher pressure. Typically, a back pressure valve may be placed between the well and the test separator which is used to raise the pressure in the flow line from the well. There is a need for a test separator that will provide an accurate determination of the amount of gas, oil and water in a production stream over a wide range of production rates, without modifying the separator for individual wells, or production rates and that is easily and efficiently movable to any desired number of test locations.

### SUMMARY

An apparatus for determining the amount of oil and gas produced from a well is disclosed. The apparatus comprises a mobile test separator. The mobile test separator includes a separator unit mounted to a wheeled trailer that is movable or towable on roads, highways and on other surfaces so that the test separator may be moved to any number of desired test sites. The separator unit is a two-phase separator for separating a production string from the well being tested into a gas production stream and a liquid production stream. A liquid discharge line is connected to the separator. A pump will pump liquid through the liquid line from the separator and through meters that may include, for example, a flow meter and a water cut meter. Signals representing measurements taken from the flow meter or water cut meter will be sent to a computer which will calculate the flow of oil, the flow of water and the total flow of liquid over a defined period.

The test separator is a mobile test separator and thus may be moved from well to well or from a header to header wherein each header may be connected to production lines from wells in a group of wells. The separator unit, computer and piping necessary to determine the production from a well are mounted to the trailer so that the unit is a self-contained test separator. The only external device required is a power source to which the test separator must be connected to operate equipment thereon that requires power including, for example, the computer and an air compressor that will operate valves on the test separator.

### BRIEF DESCRIPTION OF THE DRAWINGS

FIG. 1 is a top schematic view of the disclosed test separator.

FIG. 2 is a schematic representation of the side view of the test separator with details removed for ease of explanation.

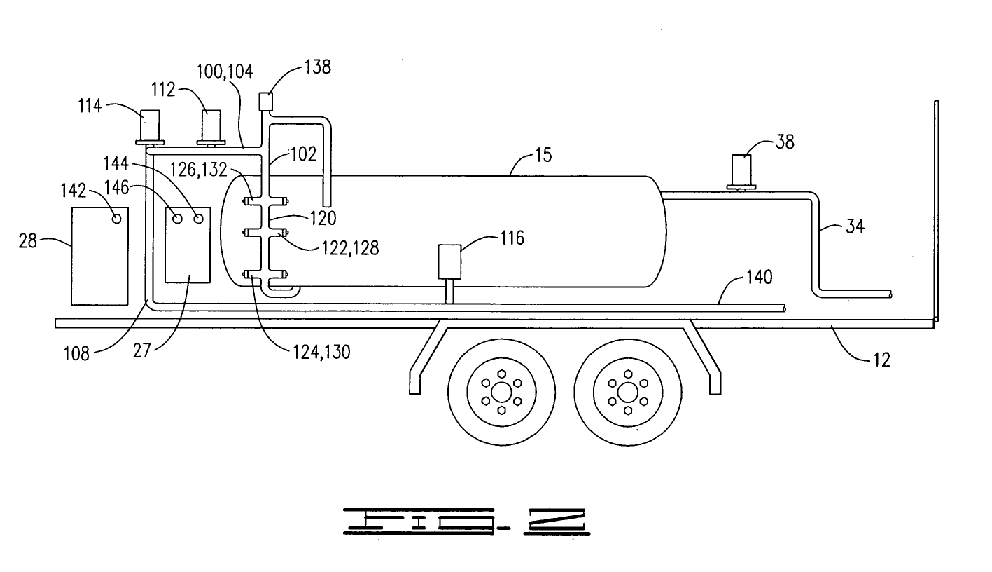

FIGS. 3 and 4 are views of the front end with details removed for ease of explanation.

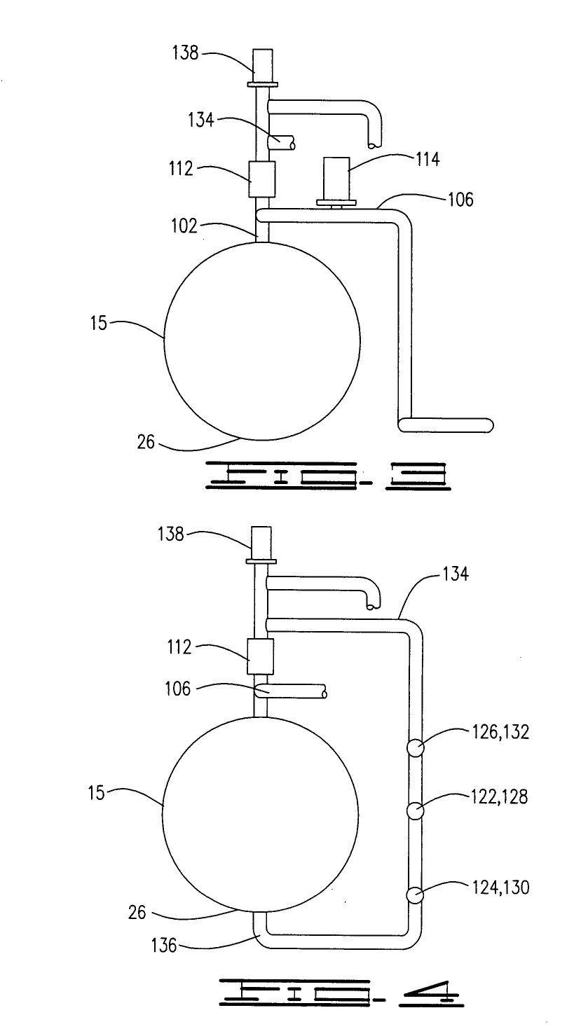

FIG. 5 is a schematic representation of the side view opposite the view of FIG. 2 with details removed for ease of explanation.

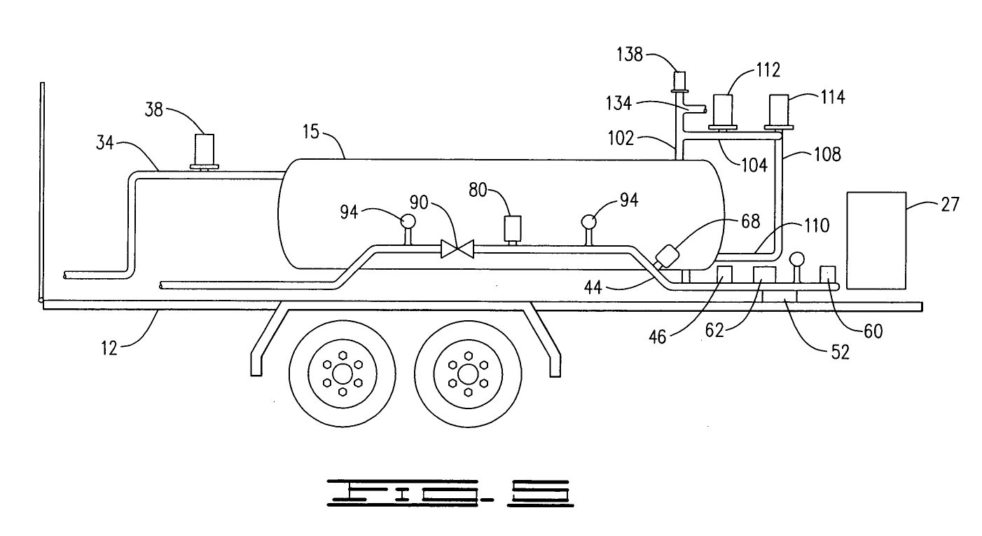

FIG. 6 is a line drawing to represent the flow of fluid through the separator.

### DESCRIPTION OF A PREFERRED EMBODIMENT

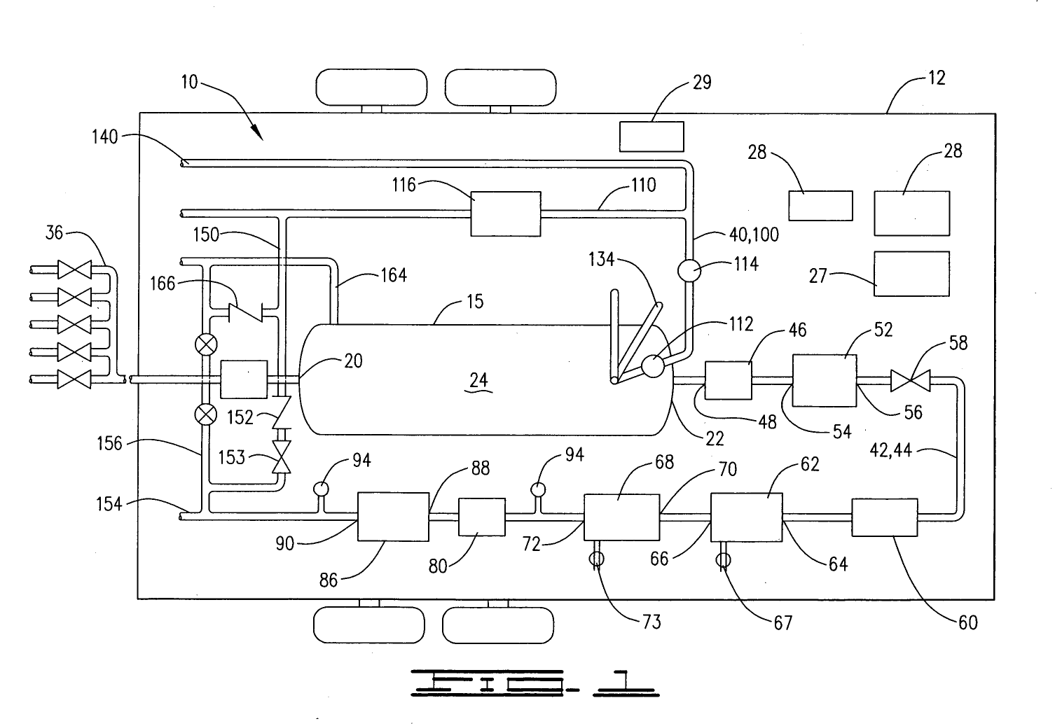

Referring now to the figures and more particularly to FIG. 1, a test separator 10 is schematically shown. As will be explained in more detail, test separator 10 will receive a production stream from a well and will separate the production stream into a gas production stream and liquid production stream. The liquid production stream will in most cases comprise oil and water. The flow rate of the gas production stream and liquid production stream are measured by the test separator 10 which also measures the amount of oil and water in the liquid production stream.

The production stream from the well may be directed into a separator unit 15 which has a forward end 20, a rear end 22, a top 24 and a bottom 26. Test separator 10 includes an air compressor 27, an electric panel 28, and a computer 29 which may be referred to as a net oil computer 29. Computer 29 may be, for example, a Red Eye 2G NOC (net oil computer) available from eProduction Solutions. Air compressor 27 and electric panel 28 will be connected to, and provide air and power to valves, pumps and other equipment in the test separator 10 for the electric and pneumatic control of such components. Electric and pneumatic connections are not shown, and it is understood that such connections are known in the art. Test separator 10, including air compressor 27, electric panel 28 and computer 29, may be mounted to a wheeled trailer 12, which may be, for example, an 18-20 foot trailer that can be moved along roads and highways behind a pulling vehicle to a desired test location. The length of the trailer may vary, but will be movable between different test locations. The test location may be a single well, or a header location which is capable of receiving the production lines from a group of wells.

Inlet line 34 may be connected to a valved header 36 that is connected to several wells so that the production stream from each of the wells connected to header 36 may be individually directed through test separator 10. Alternatively, test separator 10 may be connected directly to the flow line from an individual well so that the production stream therefrom flows into separator unit 15. The production stream will be separated in separator unit 15 into a gas stream and a liquid stream which will include both oil and water. It may be that a very small amount of gas is entrained in the liquid stream but the gas therein is negligible and is an insufficient amount to impact the effectiveness or operation of test separator system 10. Test separator 10 will efficiently and effectively determine production from a well and will do so for a wide range of production rates. For example, test separator 10 may be used for wells that produce as little as one bbl/day and moved and used on a well that produces as much as 1600 bbl/day. Prior art test separators are limited in the range of production which can be accurately measured. For example, test separators using turbine meters are limited since the effective range of production which can be measured is directly tied to the size of the turbine meter. For example, a ⅜″ turbine meter has a range of approximately 10-100 BPD, a half-inch turbine meter has a range of 25-250 BPD and a ¾ inch turbine meter has a range of 68-515 BPD. Thus, the volume capability increases with turbine meter size. Different test separators with turbine meters of different capacities must be used, and in some cases where it is desired to test a group of wells in a single field, it will be necessary to use several different test separators.

Test separator 10 can be used to accurately and efficiently test wells with a wide range of production as set forth herein. In addition, the test separator 10 is mobile, and self-contained in that it needs only to be connected to an external power source at the location in which it is used to provide power through electric panel 28, which will provide electric power to computer 29, air compressor 27, and other components in the test separator 10. Known test separators are generally stationary and cannot be removed from a location and used in second, third and other locations as desired, without significant disassembly. Known portable testers may not measure accurately due to the pressure increase required for operation and due to the measurement of the fluid through fixed meters such as turbine meters or volumetric tubes.

An inlet back pressure valve 38 is positioned in inlet line 34. Back pressure valve 38 is designed to maintain pressure in inlet line 34 to simulate flow line pressure on the well. As provided herein back pressure valves are used with prior art test separators to raise the pressure above the normal flow line pressure of the well being tested, which can have a negative impact on production from a well. Back pressure valve 38 is adjusted to maintain normal flow line pressure between the back pressure valve 38 and the well being tested. Inlet line 34 will be connected to separator unit 15 at or near top 24 at forward end 20 thereof. Separator unit 15 separates the well production stream into a gas production stream and a liquid production stream which for ease of reference be referred to as gas production stream 40 and a liquid production stream 42.

Liquid production stream 42 flows into a liquid line 44 that is connected at or near rear end 22 and at or near bottom 26 of separator unit 15. Liquid line 44 may be mounted to trailer 12 with brackets and other known mounting methods. A dump valve 46 with a dump valve inlet 48 and a dump valve outlet 50 is connected in liquid line 44. A pump 52 which is preferably a centrifugal pump 52 is connected in liquid line 44 and has a pump inlet or inlet side 54 and pump outlet or outlet side 56. Pump 52 may also be mounted directly to a floor of trailer 12. A manually activated ball valve 58 may be positioned between pump 52 and a mixer 60 which is adapted to further mix the water and oil in liquid production stream 42 to obtain a heterogeneous flow so that proper and accurate measurements can be taken with meters downstream of mixer 60. Downstream of mixer 60 is a meter which may be referred to as a water cut meter 62. The term “water cut” is used to represent the relationship between a volume of oil and a volume of water in an oil/water mixture. Conventionally, usage of the term water cut is such that in a well production fluid, a volume of fluid that has a ninety-five percent water cut indicates that water comprises ninety-five percent of the total volume of liquid. Thus, liquid with a ninety-five percent water cut would include five percent by volume of oil. In one embodiment, the water cut meter may be a Red-Eye 2G water cut meter available from eProduction Solutions.

Water cut meter 62 has an inlet side 64 and outlet side 66 and may have a flow transmitter 67 which will be operably connected to computer 29. Liquid in flow line 44 passes through a second meter 68 which in the embodiment shown is a Coriolis meter 68. Coriolis meter 68 has an inlet side 70, an outlet side 72 and may have a flow transmitter 73 which is operably coupled to computer 29. The Coriolis meter 68 will provide within liquid flow line 44. Coriolis meter 68 may be mounted in upwardly sloped portion 45 of liquid line 44, which may angle upwardly from first horizontal portion 44a, to second horizontal portion 44b. Sloped portion 45 may angle upwardly from first horizontal portion 45 at an angle of, for example, 30 to 60 degrees, and may be, for example, 45 degrees. Coriolis meter 68 is mounted in sloped portion 45 to help insure that the Coriolis meter 68 is filled more fully with fluid during operation. Signals representing measurements will be transmitted from Coriolis meter 68 through flow transmitter 73 to the computer 29. Liquid production stream 42 passes from Coriolis meter 68 through a back pressure valve 80 which has an inlet side 82 and an outlet side 84. Back pressure valve 80 may be utilized to maintain sufficient pressure in liquid flow line 46 to allow accurate and consistent measurements by the water cut and Coriolis meters 62 and 68, respectively, and so that pump 52 operates efficiently. Liquid passes from back pressure valve 80 through check valve 86 which allows flow only in the direction described herein through the inlet side 88 thereof and out the outlet side 90 thereof. Liquid may then be flowed through liquid line 44 into a combined flow line in which gas and liquid may be recombined and directed to a production facility. In certain cases, liquid production stream 42 may flow directly from liquid line 44 to a flow line without being combined with gas from the well. For example, some wells have a flow line system that supports both a liquid flow line and a gas flow line, and in such cases, the liquid would not be recombined. Such wells are typically in production fields where the casing head gas is collected separate from the well bore fluids. Liquid line 44 may include a plurality of gauges 94 for monitoring and measuring pressure in the liquid line at different locations.

Gas production stream 40 from separator unit 15 will pass into gas line 100 from vertical gas exit pipe 102 extending from separator unit 15. Exit pipe 102 extends upwardly from top 30 of separator unit 15. Gas line 100 has a first horizontal portion 104 that may be generally parallel to the direction of separator unit 15 and a second horizontal portion 106 which may be perpendicular to the first horizontal portion 104. Second horizontal portion 106 is connected at an elbow to a downward or vertical portion 108 which is connected to a third horizontal portion 110 which may be referred to as exit line 110 that runs along side and is parallel to the direction of separator unit 15. Gas will flow up out of separator unit 15 through vertical gas pipe 102 and into horizontal portion 104 which may have a back pressure valve 112 connected therein to regulate the amount of pressure in separator unit 15 and to prevent an over pressure situation. Back pressure valve 112 will also hold pressure on the separator to aid in feeding liquid to pump 52. A pneumatic valve 114 is connected in second horizontal portion 106. Gas production stream 40 will pass through second horizontal portion 106, vertical portion 108 and into exit line 110. A meter 116 is connected in exit line 110 for measuring the total flow of gas through exit line 110. Meter 116 may be, for example, a TotalFlow MicroFlow.

A float column 120 communicated with separator unit 15 has a high level float 122, a low level float 124 and a upper limit float 126 therein. Each of floats 122, 124 and 126 has a switch associated therewith such that test separator 10 has a high level switch 128, a low level switch 130 and an upper limit switch 132. Float column 120 has an upper run 134 that is connected to vertical gas pipe 102 and a lower run 136 that is connected at tank bottom 26 so that float column 120 is communicated with separator unit 15 and will maintain the same liquid level therein as separator unit 15. Upper limit switch 132 is operably coupled with pilot valve 114 and will operate to close gas line 100 and prevent flow therethrough when the liquid level in separator unit 15 reaches the level of upper limit float 126 to prevent the communication of liquid into gas line 100. A pop-off valve assembly 138 is positioned at an upper end of vertical gas pipe 102 and will act as a safety valve and prevent gas pressure in separator unit 15 from rising above a predetermined upper pressure level, at which the pop-off valve will allow gas to flow therethrough to prevent over pressure in separator unit 15.

In operation, the production stream from the well to be tested will be directed into separator unit 15 from a well through inlet line 34. Test separator 10 is moved to the desired test location, and will be connected directly to wellhead piping at the well or to a header such as production manifold header 36. Test separator 10 is also connected to power at the test location. Prior to beginning a test, an “on” switch 142 on the electric panel 28 will provide power to a solenoid which will allow air from compressor 27 to act on and open dump valve 46, so that liquid in separator unit 15 can pass therethrough. The on switch 142 will activate pump 52 as well, preferably on a five-second time delay. When the on switch 142 is activated, air from compressor 29 will flow through an electrically activated solenoid to dump valve 46, to move dump valve 46 to an open position. Power is also directed to a timer, which will send power to a pump 52 on a five-second delay. Liquid from separator unit 15 will be pumped down to the low level therein which corresponds to the level of low level float 124. When the liquid level in separator unit 15 reaches the low level float 124, switch 130 which is connected to dump valve 46 and pump 52, will signal the solenoid associated with dump valve 46 to shut off air from compressor 27 and allow dump valve 46 to close and will also shut off power to pump 52.

Computer 29 is set up for the test by entering the test time period into the computer. Appropriate valves are opened to allow the produced fluids to be delivered into inlet line 34 through back pressure valve 38 into separator unit 15. A “Start Test” button 144 on computer 29 is pressed when the valves are opened to allow production fluid into separator unit 15. When the liquid level in tank 15 reaches the high or release level, indicated by high level float 122, the high level float switch 128 will activate the dump valve 46 by allowing air from air compressor 27 to flow through the electrically activated solenoid associated therewith and open dump valve 46. Dump valve 46, when open, allows liquid to pass therethrough into liquid line 44. Switch 128 will also activate pump 52, preferably on a five-second time delay so that pump 52 will pump the liquid production stream through liquid line 44. A production test may be run over a defined period of time such as twenty-four hours or for other specified time periods to determine a volume of oil produced over the time period. The rate of flow into separator unit 15 will generally be such that the liquid level associated with low level valve 124 will be reached one or more times during the specified test time. In other words, the rate at which pump 52 pumps liquid from separator unit 15 will generally be higher than the rate at which fluid enters separator unit 15. Pump 52 may pump as high as for example 3000 bbl/day, or can be set at any desired lower pump rate, but will be sufficient to pump the liquid to its ultimate destination such as, for example, a production line leading to a production facility.

Liquid that passes through pump 52 will pass through mixer 60 and through water cut meter 62 which will measure the percentage of oil and the percentage of water in the liquid flowing therethrough. Liquid will flow through Coriolis meter 68 which will measure mass flow rate and density measurements of liquid stream 42, and thus measures a total volume of liquid. The measurements from water cut and Coriolis meter 62 and 68 are transmitted to computer 29. Computer 29 will utilize the information transmitted thereto to calculate a total volume of liquid, and the total volume of oil and water that make up the volume of liquid that was produced during the test period. The total volume of oil can then be divided by the test time to determine the amount of oil produced over a determined period such as, for example, barrels per day.

During the test, when the flow into the separator unit 15 is such that the liquid level therein reaches low level float 124, low level switch 130 will deactivate dump valve 46 so that it moves to the closed position and will deactivate pump 52. Dump valve 46 and pump 52 will be opened and reactivated respectively when the liquid level in separator unit 15 reaches high level float 122. Switch 128 will send power through a latching relay which will latch and send power to the solenoid associated with dump valve 46, which will allow air from compressor 27 to open dump valve 46. Power will also be sent to the timer associated with pump 52, which will after the five-second delay send power to pump 52. At low level 124, switch 130 will allow power to reset the latching relay, which will allow the solenoid associated with dump valve 46 to close off the air from compressor 27, and will shut off power to pump 52. Thus, dump valve 46 may cycle through open and closed positions and pump 52 may cycle between on and off several times during a defined test period. In this manner, the flow of liquid through water cut meter 62 and Coriolis meter 68 will be steady when liquid is flowing through liquid line 44. There will generally be times during the test period in which no liquid is flowing through liquid line 44, but when liquid is flowing it will be a constant flow created by pump 52 to insure flow rates through both of meters 62 and 68 are at or above minimum flow rates for accuracy of measurements.

At the end of the test period, pump 52 may be in an off state. The operator therefore will push the on button 142 which will cause the dump valve 46 to open and pump 52 to activate liquid is pumped to the level of low level float 124. When the liquid is pumped to low level 124, pump 52 will deactivate and the operator will hit stop test 146 on the computer 29. The likelihood is that the operator will not be at the test separator 10 at the end of the defined test period. In other words, assuming a test period of six hours, computer 29 will automatically stop that test and store the values received from water cut meter 62 and Coriolis meter 68. The computer will also calculate total volume and the volume of oil and volume of water produced in the test period and will convert it into a barrels per day reading. These values can be read on a display on computer 29, or retrieved from computer 29 in a manner known in the art. Test separator 10 will continue operating and, computer 29 will automatically start a second test with the same defined test period. When the operator ultimately reaches test separator 10, it will likely be in the middle of a second or subsequent test as the computer will continue to run consecutive tests until the operator pushes the stop test button 146 on the computer. When the operator arrives at the well, if the pump 52 is in its off state, the operator will hit the on button 142 on the electric panel which will open the dump valve 46, start pump 52 as described herein until liquid in separator unit 15 is pumped to the level of low level float 124. The operator will then push the stop test button 146. Computer 29 will calculate the volume as described herein and will convert it in to a barrels per day unit based on the actual time of the interrupted test, along with providing the same information for the completed tests conducted prior to the time the operator stopped the test.

Gas from separator unit 15 will pass through exit line 110 and gas meter 116 therein which will measure the amount of gas flowing through exit line 110. The flow meter 116 in exit line 110 will measure the amount of gas which passes therethrough during the entire time period. In most situations, liquid flowing through liquid line 44 and gas in exit line 110 will be recombined and placed into the normal production system and delivered to a production facility for appropriate handling.

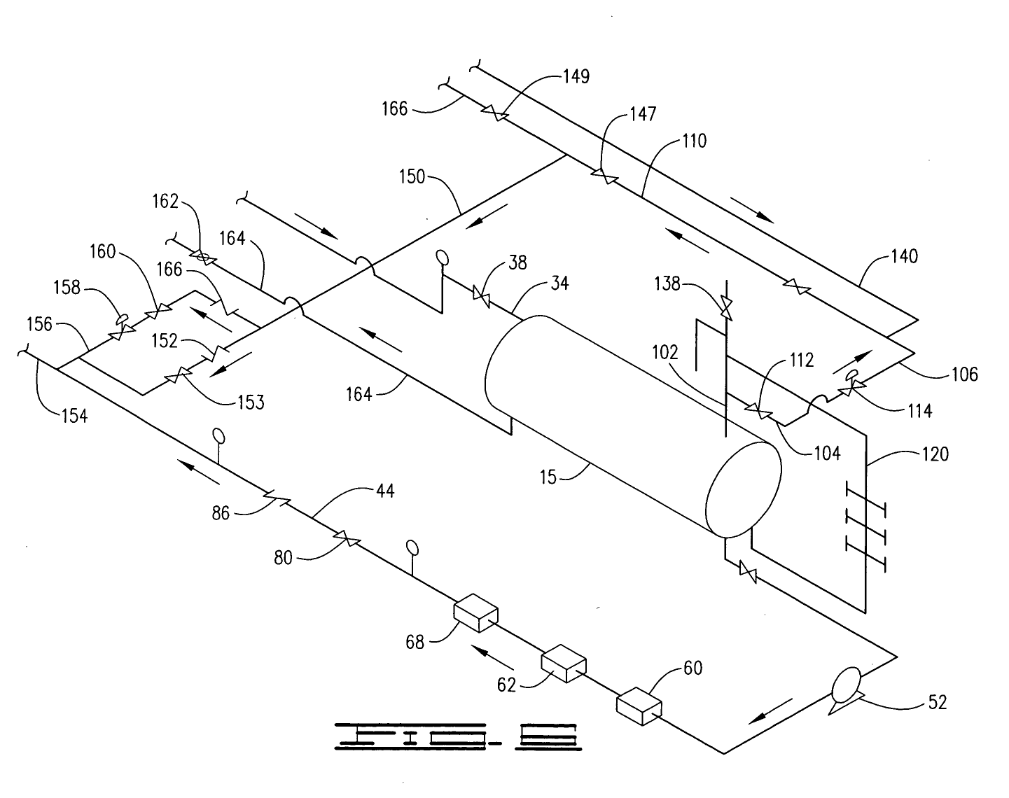

Flow may be more clearly described by referring to FIG. 6 which is a line diagram which may be utilized to show the flow. Typically, gas will flow through line 110 in a direction as shown by the arrows. Flow lines, including line 110 will be valved so that the gas production stream 40 will typically flow through a connecting line 150 which will have a check valve 152 therein to allow flow only in the direction shown. Exit line 110 may have ball valves 147 and 149 therein. Ball valve 149 will normally be closed, and a ball valve 153 in line 150 will be open. Gas will flow until it connects with liquid line 44 so that the liquid production stream and gas production stream 40 and 42, respectively, are combined to flow through an outlet 154 to a production line which will carry the combined liquid and gas production streams to a production facility. An additional flow line 156 with a pilot-actuated valve 158 and a ball valve 160 are also included. A bull plug 162 is connected to a flow line 164 which is ultimately connected to the bottom of separator unit 15. A check valve 166 is positioned in a line 168 which connects connecting line 150 with line 156. Pilot operated valve 158 is a safety feature that will open if the pressure in the separator unit 15 exceeds a predetermined limit. In such a case, liquid will flow out of separator unit 15 through lines 164 and 156 to outlet 154, and gas in line 150 will flow through lines 168 and 156 to outlet 154.

As shown in the top view in FIG. 1, an additional gas line which may be referred to as secondary gas line 140 is included. Secondary gas line 140 may be directly connected to a gas line from a well at a well location where gas has been separated at the well. Liquid and any remaining gas in the liquid from such a well will flow into the separator unit 15 as described herein through inlet line 34. Gas separated at the well will flow through line 140 and into gas line 110 which will be combined with any excess gas separated out in separator unit 15 so that a total flow of gas will again go through gas meter 110. Liquid flow through the system 10 will be as described herein.

In cases where the secondary gas line is utilized, ball valve 149 may be opened and valve 153 closed so that gas does not pass through connecting line 150, and will pass through outlet line 166. This generally will only occur in wells with a flow line system that supports both a liquid flow line and a gas flow line.

The system 10 described herein is more efficient and useful than prior test separators in that a consistent flow of liquid through the water cut and Coriolis meters 62 and 68 in liquid line 44 is insured by the placement of back pressure valve 80 and the pumping of liquid by pump 52. Thus, the measurements taken by meters 62 and 68 are more accurate and give a more accurate representation of flow over a defined test period. At the end of each test period, liquid in the separator unit 15 will be pumped down to the low level indicated by low level valve 124 so that all of the liquid received in the separator unit 15 during the test period will pass through meters 62 and 68. In other words, the level in the separator unit 15 will be at the level at which the test was started. Valves such as pop-off valve 138 may be utilized to prevent over-pressure situations. Pop-off valve 138 will only open if pressure in the tank exceeds a predetermined pressure limit.

Pilot valve 114 is likewise a safety feature which will close to prevent liquid flow into gas line 100. Pilot valve 114 will be actuated if liquid in separator unit 15 reaches an uppermost predetermined level as indicated by the uppermost float 126 in float column 120. In such a case, switch 132 will cause pilot valve 114 to by allowing air from compressor 27 to pass through a solenoid activated by switch 132 thereby closing pilot valve 114.

The test separator described herein is mobile, and all that is required to move from one test location to the next is to disconnect the external power source, disconnect the inlet line 34 from the header 36, or from the production line from a single well, and disconnect the test separator 10 unit from the production line or lines to which liquid line 44 and gas line 40 are connected. Thus, all components necessary to the operation of test separator 10 are contained on wheeled trailer 12, making the unit easily mobile and transportable to any desired test site.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. Apparatus for determining the amount of oil in a production stream for a well comprising:
a separator for separating the production stream into a gas stream and a liquid stream;
a gas discharge line connected to the separator;
a liquid discharge line for receiving the liquid stream;
a flow meter connected to the liquid discharge line;
a water cut meter for measuring and determining the percentage of oil and water in the liquid stream connected to the liquid discharge line; and
a pump connected in the liquid discharge line for pumping liquid from the separator through the discharge line and through the flow meter and water cut meter.

2. The apparatus of claim 1, further comprising:
a dump valve movable between open and closed positions, wherein in the open position the dump valve permits the liquid stream to flow therethrough in the liquid discharge line and in the closed position does not permit flow therethrough; and
a float associated with the separator for indicating a liquid level in the separator, wherein the dump valve automatically closes, and the pump automatically shuts off when the liquid level in the separator reaches a predetermined lower limit ad indicated by the float.

3. The apparatus of claim 2 wherein the dump valve will automatically open and the pump will automatically activate when the liquid level in the separator reaches a predetermined upper limit as indicated by a second float associated with the separator.

4. The apparatus of claim 1 further comprising:
a computer for receiving signals from the flow meter and water cut meters, wherein the computer is adapted to calculate the amount of oil produced from the well during a test cycle of a known time period based on the signals received from the flow meter and water cut meter.

5. The apparatus of claim 4, further comprising:
a dump valve connected to the liquid discharge line; and
floats for indicating liquid levels in the separator, wherein the dump valve is adapted to automatically cycle between open and closed positions, and the pump is adapted to automatically cycle between on and off modes during the time period of the test cycle.

6. The apparatus of claim 5:
the floats being operably associated with the dump valve, wherein the dump valve will automatically close when one of the floats indicates the liquid level is at a predetermined lower level, and will open when one of the floats indicates the liquid level is at a predetermined high level.

7. The apparatus of claim 6, the floats being operably associated with the pump, wherein the pump will automatically switch to the off mode when the floats indicate the liquid level is at the predetermined low level and will automatically switch to the on mode when the float indicates the liquid level is at the predetermined low level.

8. Method of testing well production comprising:
bringing a liquid level in a separator to a predetermined start level;
communicating a production stream from a well comprising at least a gas component and a liquid component into the separator to raise the liquid level in the separator;
separating the production stream into a gas stream and a liquid stream;
discharging the liquid stream from the separator;
pumping the liquid stream through a liquid discharge line, the liquid discharge line having a flow meter and a water cut meter connected thereto.

9. The method of claim 8 further comprising automatically activating a pump to perform the pumping step when the liquid level in the separator reaches a predetermined high level.

10. The method of claim 8, the discharging step comprising:
automatically opening a dump valve connected in the liquid discharge line when the liquid level in the separator reaches a predetermined high level to permit the liquid stream to flow through the liquid discharge line.

11. The method of claim 8 further comprising:
beginning the communicating step at a test start time; and
ceasing the communicating step at a test end time, wherein the time between the test start and test end comprise a test cycle.

12. The method of claim 11 further comprising during the test cycle:
automatically activating a pump to perform the pumping step when the liquid level reaches a predetermined high level; and
automatically opening a dump valve connected in the liquid discharge line when the liquid level reaches the predetermined high level.

13. The method of claim 12, further comprising, during the test cycle:
automatically deactivating the pump and automatically closing the dump valve when the liquid level in the separator reaches the start level; and
automatically reopening the dump valve and activating the pump when the liquid level in the separator reaches the predetermined high level.

14. The method of claim 13, further comprising:
at the end of the test cycle, ceasing communication of the production stream into the separator and discharging liquid from the separator until the liquid level in the separator is at the predetermined start level.

15. The method of claim 14, further comprising:
determining the volume of liquid communicated into the separator during the test cycle; and
calculating the percentage of oil in the liquid.

16. The method of claim 15 further comprising:
sending a signal from the flow meter to a computer processor, wherein the computer processor performs the determining step; and
sending a signal from the water cut meter to the computer processor, the computer processor performing the calculating step.

17. A mobile production separator comprising:
a wheeled trailer;
a separator mounted to the trailer for separating a well production stream into a gas stream and a liquid stream;
a liquid line movable with the trailer for receiving the liquid production stream;
a pump mounted to the trailer for pumping the liquid stream through the liquid line;
a water cut meter coupled to the liquid line downstream from the pump; and
a flow meter coupled to the liquid line downstream from the pump.

18. The mobile separator of claim 17 further comprising a series of floats for indicating predetermined low, high and upper limit liquid levels in the tank, wherein the pump automatically shuts off when the series of floats indicates the low level and automatically activates when the float indicates the high level.

19. The mobile separator of claim 18, further comprising a dump valve connected in the liquid line, wherein the dump valve automatically closes at the low level, and automatically opens at the high level, and wherein the automatic activation of the pump occurs on a time delay, so that the pump activates after the dump valve opens.

20. The mobile separator of claim 17 further comprising a computer mounted to the trailer wherein the flow and water cut meters send signals to the computer representing flow rates and volume percentages of oil and water in the liquid stream.

21. A method of testing the production of a plurality of wells comprising:
positioning a mobile test separator comprising a separator unit mounted to a trailer for connection to a flow line from a well;
directing the production stream from the well into the separator unit;
separating the production stream into a liquid production stream and a gas production stream; and
pumping the liquid production stream through flow and water cut meters movable with the trailer.

22. The method of claim 21 further comprising moving the mobile test separator to a second well and performing the directing, separating and pumping steps of claim 21 for the second well.

23. The method of claim 21 further comprising:
calculating a flow rate of oil from the well production stream based on movements taken by the water cut and flow meters;
determining the gas flow rate from the production stream; and
combining the liquid production stream and gas production stream after the calculating and determining step.

24. The method of claim 21, further comprising:
indicating low and high liquid levels in the separator unit; and
automatically deactivating and activating the pump to stop and start the pumping step at the low and high levels, respectively.

25. The method of claim 24, wherein the automatically activating step occurs on a time delay after the high level is indicated.
